(19) United States
(12) Patent Application Publication
(10) Pub. No.: US 2014/0119055 A1
(43) Pub. Date: May 1, 2014

(54) Light Coupling Arrangement of Backlight Module

(71) Applicant: Yanxue Zhang, Shenzhen City (CN)

(72) Inventor: Yanxue Zhang, Shenzhen City (CN)

(73) Assignee: Shenzhen China Star Optoelectronics Technology Co., LTD., Shenzhen City, Guangdong Province (CN)

(21) Appl. No.: 13/806,749

(22) PCT Filed: Nov. 19, 2012
(86) PCT No.: PCT/CN2012/084797

§ 371 Date: Dec. 21, 2012

(30) Foreign Application Priority Data
Oct. 31, 2012 (CN) 201210428145.2

(51) Int. Cl. F21V 8/00

(52) U.S. Cl. CPC G02B 6/0073
USPC 362/621

(57) ABSTRACT

The present invention relates to a light coupling arrangement of a backlight module, which includes a heat dissipation board, an LED light bar, a light guide plate, and a backplane. The heat dissipation board is positioned at a light incidence side of the light guide plate and fixed to the backplane. The LED light bar is fixed to the heat dissipation board and opposes the light incidence side of the light guide plate. The heat dissipation board forms a bump that faces the light incidence side of the light guide plate. The bump has a top that is in contact with the light incidence side of the light guide plate to constrain movement of the light guide plate in a light incidence direction. The light guide plate has a light-opposite side, and an elastic structure is received between the light-opposite side and a side wall of the backplane.

### BACKGROUND OF THE INVENTION

1. Field of the Invention

The present invention relates to a backlight module, and in particular to a light coupling arrangement of a backlight module.

2. The Related Arts

A backlight module is one of the key components of a liquid crystal display device and is widely used in various electronic products, including personal digital assistant (PDA), digital camera, global positioning system, and flat panel television. With the increasing expansion of the terminal application of light-emitting diodes (LEDs), it is a definite trend that LED backlight sources will replace the cold cathode fluorescent lights. The backlight sources can be classified in two types, namely direct LED backlight module and side-edge LED backlight module, according to the location where the light source is set. The direct LED backlight module is generally constructed by uniformly distributing LED chips on a back side of a liquid crystal panel to serve as a light source, so as to have the backlighting uniformly transmitting to the entire panel. The side-edge LED backlight module is generally constructed by arranging LED chips at four edges of the panel, whereby light emitting from the LEDs is transmitted through a light guide plate (LGP) to an area at the center of the panel. Since the side-edge LED backlight module arranges the light source by the edges of the light guide plate, it is fit for small-sized liquid crystal displaying products and is gaining increasing attention.

The conventional mass-produced side-edge LED backlight module often uses an LGP to serve as a light guide element. In a conventional backlight module that contains aluminum extruding, two cutoffs are formed in the LGP through cutting and positioning pegs are mounted to the cutoffs to mount the LGP to the aluminum extruding, wherein the LEDs are located at one side of the LGP and are fixed to the aluminum extruding. In product designing, a distance between the LGP and LEDs is vital in affecting light coupling efficiency. If the distance between the LGP and the LEDs is great, the problem that light coupling efficiency lowers down will occur. If the light coupling distance is small, then the problem that the LEDs are crushed down by the LGP or molten by the high temperature of the LGP will occur. Due to such problems, the light coupling distance between the LGP and the LEDs is a difficult and important issue for designing side-edge backlighting. The known techniques cannot provide a promising light coupling distance between LEDs and LGP of a backlight module and this is because the light coupling distance is affected by various parameters, such as precision of diameter of the positioning pegs that mount the LGP, cutting tolerance of the LGP, tolerances of surface mounting of LED and manufacturing of printed circuit board, and thickness of heat dissipative soldering disk. The primary parameters that affect the light coupling distance are positioning and dimensional variation of the LGP. Once the positioning arrangement of LGP is controlled, well control can also be obtained for the light coupling distance.

Referring to FIG. 1, a plot is given to show the relationship between the light coupling distance and light efficiency, wherein abscissa indicates a light coupling distance (mm) and ordinate is efficiency. It can be seen from the plot that the smaller the light coupling distance is, the higher the light coupling efficiency will be. Referring to FIG. 2, a schematic view is given to show a conventional positioning structure of light guide plate. In this arrangement, the light guide plate 1 is arranged on a backplane 2. The position that the light guide plate 1 is set on the backplane 2 is determined by a positioning peg 3. The positioning peg 3 can be a rivet and the rivet is set at a middle position of the light guide plate 1. Thus, the rivet must be mounted to the backplane 2 and the light guide plate 1 must be properly cut in advance to form a cutoff for positioning the rivet. Material tolerance, assembling tolerance, and expansion will be applied to a light incidence side, leading to instability of the light coupling distance.

### SUMMARY OF THE INVENTION

Thus, an object of the present invention is to provide a light coupling arrangement of a backlight module that simplifies a positioning structure of light guide plate and enhance the light coupling efficiency between the light guide plate and light-emitting diodes (LEDs).

To achieve the object, the present invention provides a light coupling arrangement of a backlight module, which comprises a heat dissipation board, an LED light bar, a light guide plate, and a backplane. The heat dissipation board is positioned at a light incidence side of the light guide plate and fixed to the backplane. The LED light bar is fixed to the heat dissipation board and opposes the light incidence side of the light guide plate. The heat dissipation board forms a bump that faces the light incidence side of the light guide plate. The bump has a top that is in contact with the light incidence side of the light guide plate to constrain movement of the light guide plate in a light incidence direction. The light guide plate has a light-opposite side and an elastic structure is received between the light-opposite side and a side wall of the backplane.

Wherein, the elastic structure comprises a spring.

Wherein, the elastic structure comprises an elastic material.

Wherein, in a direction perpendicular to the light incidence direction, the backplane forms, on a sidewall thereof, a raised platform that opposes one side of the light guide plate to contact the light guide plate and a cushioning material is received between the sidewall of the backplane and an opposite side of the light guide plate.

Wherein, the heat dissipation board forms bolt holes and the heat dissipation board is fixed to the backplane with bolts.

Wherein, the heat dissipation board is provided with a bump at each of two oppose ends thereof.

Wherein, the bumps are formed by means of stamping.

Wherein, the bumps have height error that is controlled within 0.1 mm.

Wherein, a distance between the light guide plate and LED light bar is 0.2 mm.

The present invention also provides a light coupling arrangement of a backlight module, which comprises a heat dissipation board, an LED light bar, a light guide plate, and a backplane, the heat dissipation board being positioned at a light incidence side of the light guide plate and fixed to the backplane, the LED light bar being fixed to the heat dissipation board and opposing the light incidence side of the light guide plate, the heat dissipation board forming a bump that faces the light incidence side of the light guide plate, the bump having a top that is in contact with the light incidence side of the light guide plate to constrain movement of the light guide plate in a light incidence direction, the light guide plate having a light-opposite side, an elastic structure being received between the light-opposite side and a side wall of the backplane;

wherein the elastic structure comprises a spring;

wherein in a direction perpendicular to the light incidence direction, the backplane forms, on a sidewall thereof, a raised platform that opposes one side of the light guide plate to contact the light guide plate, a cushioning material being received between the sidewall of the backplane and an opposite side of the light guide plate;

wherein the heat dissipation board forms bolt holes and the heat dissipation board is fixed to the backplane with bolts;

wherein the heat dissipation board is provided with a bump at each of two oppose ends thereof;

wherein the bumps are formed by means of stamping;

wherein the bumps have height error that is controlled within 0.1 mm; and

wherein a distance between the light guide plate and LED light bar is 0.2 mm.

The present invention provides a light coupling arrangement of a backlight module that improves the light coupling efficiency of the module and simplifies assembling structure of light guide plate. Rivet of the backplane and cutting of the light guide plate can be eliminated so as to simplify the assembling structures of the light guide plate and backplane.

### BRIEF DESCRIPTION OF THE DRAWINGS

The technical solution, as well as beneficial advantages, will be apparent from the following detailed description of embodiments of the present invention, with reference to the attached drawings. In the drawings:

FIG. 1 is a plot showing the relationship between a light coupling distance and light efficiency;

FIG. 2 is a schematic view showing a conventional positioning structure of light guide plate;

FIG. 3 is a schematic view showing a positioning arrangement of a light incidence side of the light guide plate in the light coupling arrangement of a backlight module according to the present invention;

FIG. 4 is a schematic view showing a positioning arrangement of a light-opposite side of the light guide plate in the light coupling arrangement of a backlight module according to an embodiment of the present invention;

FIG. 5 is a schematic view a manner of positioning applied to a light-opposite side of the light guide plate in the light coupling arrangement of a backlight module according to another embodiment of the present invention;

FIGS. 6 and 7 are schematic views illustrating assembling made in a direction perpendicular to light incidence of the light coupling arrangement of a backlight module according to the present invention; and

FIG. 8 is a schematic view showing a heat dissipation board and a positioning structure thereof of the light coupling arrangement of a backlight module according to the present invention.

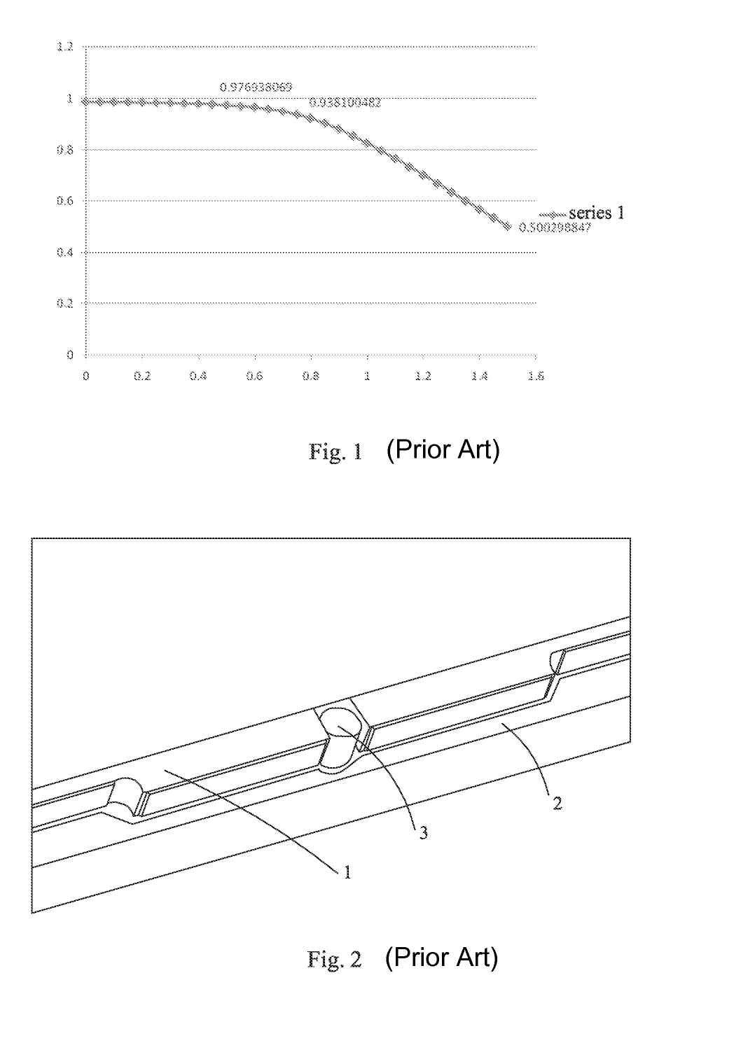

### DETAILED DESCRIPTION OF THE PREFERRED EMBODIMENTS

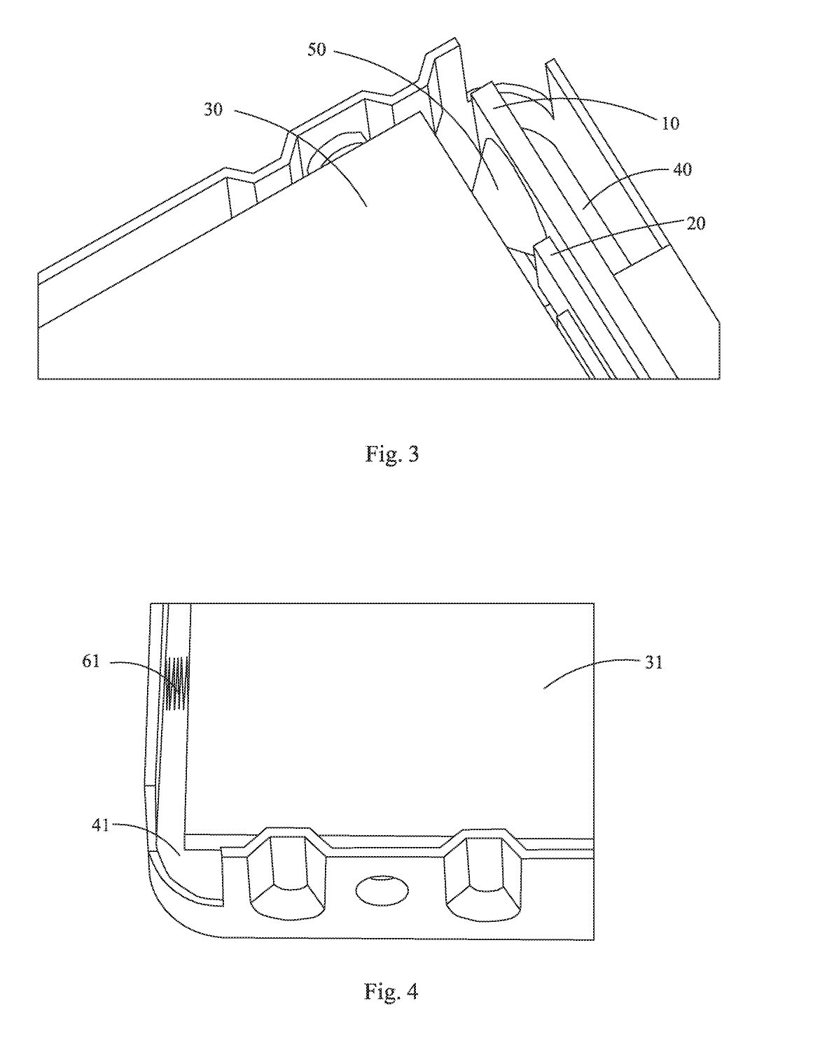

Referring to FIG. 3, which is a schematic view showing a positioning arrangement of a light incidence side of a light guide plate of the light coupling arrangement of a backlight module according to the present invention, the light coupling arrangement of a backlight module according to the present invention comprises a heat dissipation board 10, an LED light bar 20, a light guide plate 30, and a backplane 40. The heat dissipation board 10 is positioned at a light incidence side of the light guide plate 30 and is fixed to the backplane 40. The LED light bar 20 is fixed to the heat dissipation board 10 and opposes the light incidence side of the light guide plate 30. The heat dissipation board 10 forms a bump 50 that faces the light incidence side of the light guide plate 30. The bump 50 has a top that is in contact with the light incidence side of the light guide plate 30 to constrain movement of the light guide plate 30 in the light incidence direction. The light guide plate 30 has a light-opposite side and an elastic structure is received between the light-opposite side and a side wall of the backplane 40. The bump 50 can be formed through stamping. The LED light bar 20 is attached to the heat dissipation board 10 and the heat dissipation board 10 is provided with the bump 50 with the top of the bump 50 contacting the light guide plate 30, so that due to the dimensional stability of stamped part, the light coupling distance can be effectively controlled.

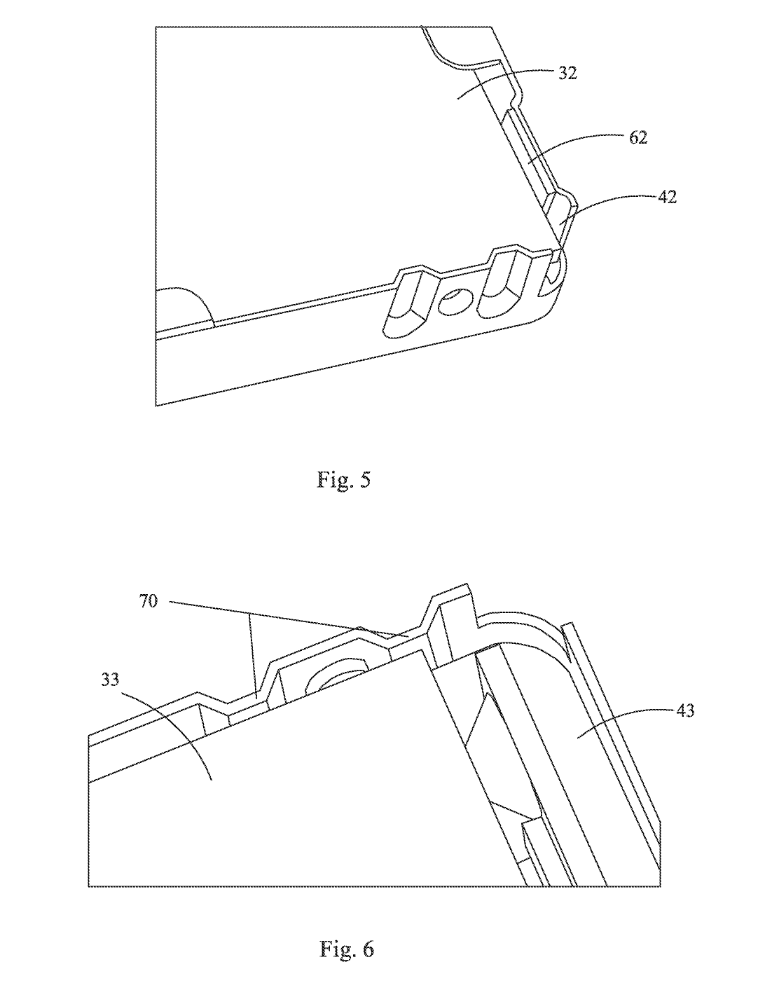

Referring to FIGS. 4 and 5, FIG. 4 is a schematic view showing a positioning arrangement of a light-opposite side of the light guide plate according to an embodiment of the present invention and FIG. 5 is a schematic view showing a positioning arrangement of the light-opposite side of the light guide plate according to another embodiment. In FIG. 4, the light guide plate 31 has a light-opposite side and a spring 61 that serves as an elastic structure is received between the light-opposite side and a side wall of a backplane 41. In FIG. 5, an elastic material 62 that serves as the elastic structure is received between the light-opposite side of a light guide plate 32 and a side wall of a backplane 42. The elastic material 62 can be made in the form of an elastic pad and specifically, is made of a rubber material. The light-opposite side is supported by the spring 61 or the elastic material 62 to effectively absorb part tolerance and expansion so as to avoid that dimension variation of the light guide plate cannot be properly released thereby leading to deflection of the light guide plate.

The light coupling arrangement of a backlight module according to the present invention comprises a positioning bump provided on a heat dissipation board of a backlight light bar to limit the movement of the light incidence side of the light guide plate and a spring or an elastic material provided at a light incidence side to position the light guide plate. Sine a metal stamping provides an excellent dimensional operation so that the height error of the bump can be controlled within 0.1 mm, thereby ensuring a small light coupling distance at the light incidence side can be ensure. The elastic structure at the light-opposite side can effectively absorb the manufacturing tolerance of light guide plate and expansion caused by humidity and heating so as to effectively prevent warping caused by dimension variation of the light guide plate.

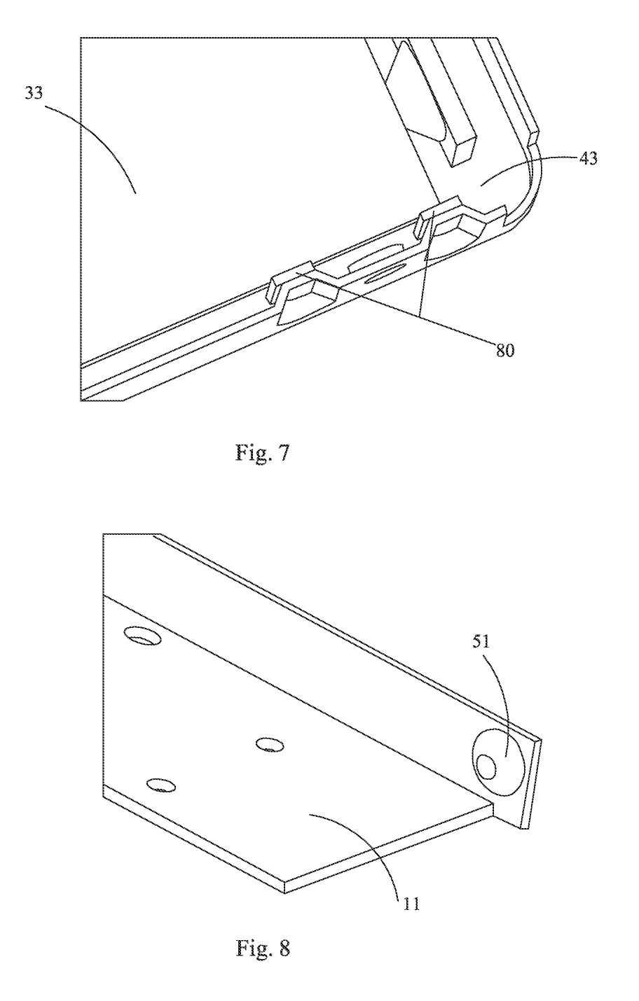

Referring to FIGS. 6 and 7, schematic views are given to illustrate assembling made in a direction perpendicular to light incidence of the light coupling arrangement of a backlight module. In the direction perpendicular to the light incidence direction, a backplane 43 forms, on a sidewall thereof, a raised platform 70 that opposes one side of the light guide plate 33 to contact the light guide plate 33. A cushioning material 80 is received between the sidewall of the backplane 43 and an opposite side of the light guide plate 33. Since this direction has no effect on the light coupling distance, positioning in this direction can be made by means of raised platform 70 formed on the backplane 43, while the cushioning material 80 can be used to fill the opposite side so as to effectively control the movement of the light guide plate. With one side done with clearance-free assembling and the opposite side done with cushioning assembling, variation of dimension of the light guide plate 33 that leads to warping can be avoided.

Referring to FIG. 8, a schematic view is given to show the heat dissipation board and positioning structure thereof of the light coupling arrangement of a backlight module according to the present invention. The heat dissipation board 11 forms bolt holes and the heat dissipation board 101 can be fixed to the backplane with bolts. The heat dissipation board 11 can be provided with a bump 51 at each of two oppose ends thereof. Alternatively, a proper number of bumps can be selectively provided at suitable locations.

The manner of positioning the light guide plate in the light coupling arrangement of a backlight module according to the present invention allows the distance between the light guide plate and LEDs to be controlled at the minimum value (0.2 mm) so as to improve the light efficiency by about 3%. Meanwhile, this arrangement achieves stability of the light coupling distance through controlling movement of the light guide plate and the reducing variation.

In summary, the present invention provides a light coupling arrangement of a backlight module that has the following advantages: (1) The light coupling efficiency of the module is improved; and (2) rivet of the backplane and cutting of the LGP can be avoided so as to simplify the assembling structures of LGP and backplane to thereby realize optimization of component cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A light coupling arrangement of a backlight module, comprising a heat dissipation board, an LED light bar, a light guide plate, and a backplane, the heat dissipation board being positioned at a light incidence side of the light guide plate and fixed to the backplane, the LED light bar being fixed to the heat dissipation board and opposing the light incidence side of the light guide plate, the heat dissipation board forming a bump that faces the light incidence side of the light guide plate, the bump having a top that is in contact with the light incidence side of the light guide plate to constrain movement of the light guide plate in a light incidence direction, the light guide plate having a light-opposite side, an elastic structure being received between the light-opposite side and a side wall of the backplane.

2. The light coupling arrangement of a backlight module as claimed in claim 1, wherein the elastic structure comprises a spring.

3. The light coupling arrangement of a backlight module as claimed in claim 1, wherein the elastic structure comprises an elastic material.

4. The light coupling arrangement of a backlight module as claimed in claim 1, wherein in a direction perpendicular to the light incidence direction, the backplane forms, on a sidewall thereof, a raised platform that opposes one side of the light guide plate to contact the light guide plate, a cushioning material being received between the sidewall of the backplane and an opposite side of the light guide plate.

5. The light coupling arrangement of a backlight module as claimed in claim 1, wherein the heat dissipation board forms bolt holes and the heat dissipation board is fixed to the backplane with bolts.

6. The light coupling arrangement of a backlight module as claimed in claim 1, wherein the heat dissipation board is provided with a bump at each of two oppose ends thereof.

7. The light coupling arrangement of a backlight module as claimed in claim 1, wherein the bumps are formed by means of stamping.

8. The light coupling arrangement of a backlight module as claimed in claim 1, wherein the bumps have height error that is controlled within 0.1 mm.

9. The light coupling arrangement of a backlight module as claimed in claim 1, wherein a distance between the light guide plate and LED light bar is 0.2 mm.

10. A light coupling arrangement of a backlight module, comprising a heat dissipation board, an LED light bar, a light guide plate, and a backplane, the heat dissipation board being positioned at a light incidence side of the light guide plate and fixed to the backplane, the LED light bar being fixed to the heat dissipation board and opposing the light incidence side of the light guide plate, the heat dissipation board forming a bump that faces the light incidence side of the light guide plate, the bump having a top that is in contact with the light incidence side of the light guide plate to constrain movement of the light guide plate in a light incidence direction, the light guide plate having a light-opposite side, an elastic structure being received between the light-opposite side and a side wall of the backplane. wherein the elastic structure comprises a spring;
wherein in a direction perpendicular to the light incidence direction, the backplane forms, on a sidewall thereof, a raised platform that opposes one side of the light guide plate to contact the light guide plate, a cushioning material being received between the sidewall of the backplane and an opposite side of the light guide plate;
wherein the heat dissipation board forms bolt holes and the heat dissipation board is fixed to the backplane with bolts;
wherein the heat dissipation board is provided with a bump at each of two oppose ends thereof;
wherein the bumps are formed by means of stamping;
wherein the bumps have height error that is controlled within 0.1 mm; and
wherein a distance between the light guide plate and LED light bar is 0.2 mm.
